(19) United States
(12) Patent Application Publication
(10) Pub. No.: US 2005/0111314 A1
(43) Pub. Date: May 26, 2005

(54) Write control parameter optimizing apparatus, write control parameter optimizing method, recording apparatus, and recording method

(75) Inventor: Tadashi Kojima, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/995,568

(22) Filed: Nov. 24, 2004

(30) Foreign Application Priority Data
Nov. 26, 2003 (JP) 2003-395898

(51) Int. Cl. G11B 5/09

(52) U.S. Cl. 369/47.5; 369/59.11

(57) ABSTRACT

A write control parameter optimizing apparatus for use in a recording apparatus for recording digital data in a recording medium, comprises means for recording random data as data packets by using different write pulse lights determined by increasing and decreasing a write control parameter, means for detecting jitter from each of reproduced data packets, and means for determining an optimal value of the write control parameter according to a detection result of the detecting means.

### CROSS-REFERENCE TO RELATED APPLICATIONS

This application is based upon and claims the benefit of priority from prior Japanese Patent Application No. 2003-395898, filed Nov. 26, 2003, the entire contents of which are incorporated herein by reference.

### BACKGROUND OF THE INVENTION

1. Field of the Invention

The present invention relates to a write control parameter optimizing apparatus and method for optimizing a write control parameter in the case where digital data is recorded in an optical recording medium such as an optical disk. More particularly, the present invention relates to an apparatus and method for setting an optimal write control parameter on a recording medium by medium basis in the case where various types of recording media are supported. In addition, the present invention relates to a write control parameter optimizing apparatus and method for setting an optimal value of a write control parameter on a recording medium by medium basis after setting the optimal value on a recording location by location basis of the parameter while in general data recording, and a recording apparatus and method having the optimizing apparatus and method incorporated therein.

2. Description of the Related Art

There has been an increased demand for an information recording and reproducing system using an optical recording medium such as an optical disk because of the prevalence of a CD-R/RW disk compatible system. In recent years, since a DVD system was announced and expansion of a recording capacity was made, the information recording and reproducing system has rapidly prevailingly increased. Today, these drives are mounted in most personal computers. Unlike a hard disk, in such a recording and reproducing system utilizing an optical disk, information is transmitted through a medium. That is, a recording medium functions as a bridge medium. As a result, the recording and reproducing system requires defining characteristics in the middle of a recording process and a reproducing process.

However, recording media are different from manufacturers, and even in the same manufacturer, their characteristics are different from each other. Further, system components of the recording and reproducing drives include their specific characteristics and variations, and as a result, the recording and reproducing drives have their specific recording and reproducing characteristics. In the case where such a variation in recording media and recording and reproducing drives are tolerated, if information has been recorded in different media in variation drives, it is mandatory as a bridge media recording and reproducing system that a reproduction signal is recorded and controlled so as to be included in a predetermined range. What is a further problem is that the DVD system supports three types of media such as DVD-R, DVD-RW, and DVD-RAM as structures of recording media capable of carrying out recording; recording control schemes according to types of the recording media are different from each other; and thus, the system becomes more complicated.

As an example, there has been proposed an optical information recording and reproducing apparatus for controlling writing power and erasing power so that a reproduction signal of a signal recorded in a DVD-RAM medium is included in a predetermined range (refer to, for example, paragraphs 0012 and 0013 and FIG. 1 of Japanese Patent Application KOKAI Publication No. 2003-132538).

In this apparatus, a trial write operation is made in combination of writing power and erasing power which are different from each other depending on sectors in a test region provided in the innermost periphery of a disk. Then, the writing power and erasing power are obtained, each of which minimizes the number of error edges based on a jitter during reproduction.

That is, recommended write control parameters (writing power and erasing power) are recorded in advance in a recording medium. Referring to the parameters, a drive adjusts and records parameter values; reproduces recorded test signals to detect jitter values; and sets an optimal value of the write control parameters.

Now, a specific processing operation will be described here. First, a random signal is recorded with increasing (or decreasing) a reference value of a parameter recorded in a recording medium to a plus (or minus) side by a specific level, then reproduction processing is carried out, and a jitter value is detected and stored. Next, a random signal is recorded with decreasing (or increasing) a reference value of a parameter recorded in a recording medium to a minus (or plus) side by a specific level, then reproduction processing is carried out, and a jitter value is detected and stored. A new reference value of a parameter is predicted from the stored jitter value. Based on the thus predicted parameter, a parameter is then increased and decreased to a plus (or minus) side, and detection of a random signal recording/reproduction jitter value is carried out. By repeating this operation, the increase and decrease of the parameter value from the reference parameter to the plus or minus side is alternately carried out, and a correction level of the parameter value is gradually reduced. In this manner, an optimal write control parameter with high reliability is detected, so that the detected parameter can be set as a write control parameter during recording of a main signal.

In such a conventional method for detecting an optimal parameter, however, it is necessary to carry out a recording process and a reproducing process alternately. Thus, since there has been a defect that a large amount of time intervals is required for the detection, and a plurality of write operations must be made in a test region, there has been a problem that a recording film at the test region is degraded earlier. Further, more climbing detection points increase higher reliability of an optimal value. However, it has been difficult to increase the number of climbing detection points than necessary because the recording and reproducing repetition count is increased.

Further, an optimal parameter of a recording medium to be used is detected in a test region, and a write control parameter of a main signal is extracted. There is a possibility that an optimal recording condition is slightly different depending on individual locations of a medium, for example, the inner periphery, the vicinity of the center, and the outer periphery of the medium. However, it is difficult to carry out processing for detecting the write control parameters on a recording location by location basis. Therefore, there has been a problem that the write control parameters detected once is unavoidably used in all regions.

Furthermore, in a write-once medium such as a DVD-R medium, a plurality of recording and reproducing operations cannot be made. Thus, when a recording and reproducing drive is developed, the drive characteristics are checked. Then, a recording medium manufacturer prepares a characteristic table showing conversion with write control parameters recorded in advance in a medium, and stores the table in a drive. In an actual write operation, the write control parameters read out from the medium used are converted in accordance with the conversion characteristic table, and an optimal write control parameter is obtained. Thus, the characteristic variation of recording media and drives of the same type cannot be eliminated, and a parameter which slightly deviates from an optimal point is unavoidably used. Therefore, there has been a problem that drive mass productivity becomes severe.

The conventional write control parameters are integrally set such that a predetermined laser power is used in units of sectors.

### BRIEF SUMMARY OF THE INVENTION

It is an object of the present invention to obtain an optimal value of a write control parameter with high reliability without degrading a recording film without alternately carry out a recording process and a reproducing process.

It is another object of the present invention to obtain an optimal value of a write control parameter on a recording location by location basis.

According to an embodiment of the present invention, a write control parameter optimizing apparatus for use in a recording apparatus for recording digital data in a recording medium by using a write pulse light determined based on a write control parameter, the write control parameter optimizing apparatus comprises:
means for recording random data as data packets by using different write pulse lights determined by increasing and decreasing the write control parameter by a predetermined value;
means for reproducing the data packets;
means for detecting jitter from each of the reproduced data packets; and
means for determining an optimal value of the write control parameter according to a detection result of the detecting means.

According to another embodiment of the present invention, a recording apparatus comprises:
means for recording random data as data packets by using different write pulse lights determined by increasing and decreasing by a predetermined value a write control parameter for determining a write pulse light for use in recording digital data in a recording medium;
means for reproducing the data packets;
means for detecting jitter from each of the reproduced data packets;
means for determining an optimal value of the write control parameter according to a detection result of the detecting means; and
means for recording digital data in the recording medium by using write pulse lights determined based on the optimal value of the write control parameter.

According to another embodiment of the present invention, a write control parameter optimizing apparatus for use in a recording apparatus for recording digital data in a recording medium by using a write pulse light determined based on a write control parameter, the write control parameter optimizing apparatus comprises:
means for recording data in a predetermined area in a predetermined error correcting code block with changing the write control parameter by a predetermined value, the error correcting code block comprising data packets, each data packet comprising rows of synchronization frames;
means for reproducing data from the predetermined error correcting code block;
means for detecting jitter from the reproduced predetermined error correcting code block; and
means for determining an optimal value of the write control parameter according to the detection result of the detecting means.

According to another embodiment of the present invention, a recording apparatus comprises:
means for recording random data as data packets by using different write pulse lights determined by increasing and decreasing by a predetermined value a write control parameter for determining a write pulse light for use in recording digital data in a recording medium;
means for recording data in a predetermined area in a predetermined error correcting code block with changing the write control parameter by a predetermined value, the error correcting code block comprising data packets, each data packet comprising rows of synchronization frames;
means for reproducing data from the predetermined error correcting code block;
means for detecting jitter from the reproduced predetermined error correcting code block; and
means for determining an optimal value of the write control parameter according to the detection result of the detecting means; and
means for recording digital data in the recording medium by using a write pulse light determined based on the optimal value of the write control parameter.

According to another embodiment of the present invention, a write control parameter optimizing method for use in a recording apparatus for recording digital data in a recording medium by using a write pulse light determined based on a write control parameter, the write control parameter optimizing method comprises the steps of:
recording random data as data packets by using different write pulse lights determined by increasing and decreasing the write control parameter by a predetermined value;
reproducing the data packets;
detecting jitter from each of the reproduced data packets; and
determining an optimal value of the write control parameter according to a detection result of the detecting step.

According to another embodiment of the present invention, a recording method comprises the steps of:
recording random data as data packets by using different write pulse lights determined by increasing and decreasing by a predetermined value a write control parameter for determining a write pulse light for use in recording digital data in a recording medium;
reproducing the data packets;
detecting jitter from each of the reproduced data packets;
determining an optimal value of the write control parameter according to a detection result of the detecting step; and
recording digital data in the recording medium by using write pulse lights determined based on the optimal value of the write control parameter.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a view showing a general process when digital main data (recording digital data) is recorded in a recording medium such as a DVD;

FIG. 2 is a view showing a general process for data reproduction of digital data read out from a recording medium such as a DVD;

FIGS. 3A and 3B are views each showing a writing waveform during recording in a DVD-RAM medium;

FIG. 4 is a view showing a structure of a lead-in area of a DVD-RAM medium;

FIGS. 5A and 5B are views each showing a writing waveform of a recording strategy of a DVD-R medium;

FIG. 6 is a view showing a configuration of an ECC block which has been row-interleaved after a correction code has been generated in a DVD;

FIG. 7 is a view showing a recording sector structure in a DVD;

FIG. 8 is a view showing a configuration of a physical sector in a DVD;

FIG. 9 is a view showing a portion of a conversion table of 8-16 RLL modulation;

FIGS. 10A and 10B are views each showing an embodiment in which a reference value of a write control parameter is corrected by a predetermined level in units of sectors in an ECC block;

FIG. 11 is a view showing another embodiment in which a reference value of a writing control value is corrected by a predetermined level in units of rows in an ECC block;

FIG. 12 is a view showing still another embodiment in which a reference value of a write control parameter is corrected by a predetermined level in units of rows in an ECC block;

FIG. 13 is a flow chart showing procedures for optimizing a write control parameter in one embodiment shown in FIGS. 10A and 10B;

FIG. 14 is a flow chart showing procedures for optimizing a write control parameter in another embodiment shown in FIG. 11;

FIG. 15 is a flow chart showing procedures for optimizing a write control parameter in still another embodiment shown in FIG. 12; and

FIG. 16 is a view showing a relationship between a writing waveform and a reproducing waveform in a DVD.

### DETAILED DESCRIPTION OF THE INVENTION

An embodiment of a write control parameter optimizing apparatus and method and a recording apparatus and method according to the present invention will now be described with reference to the accompanying drawings.

### FIRST EMBODIMENT

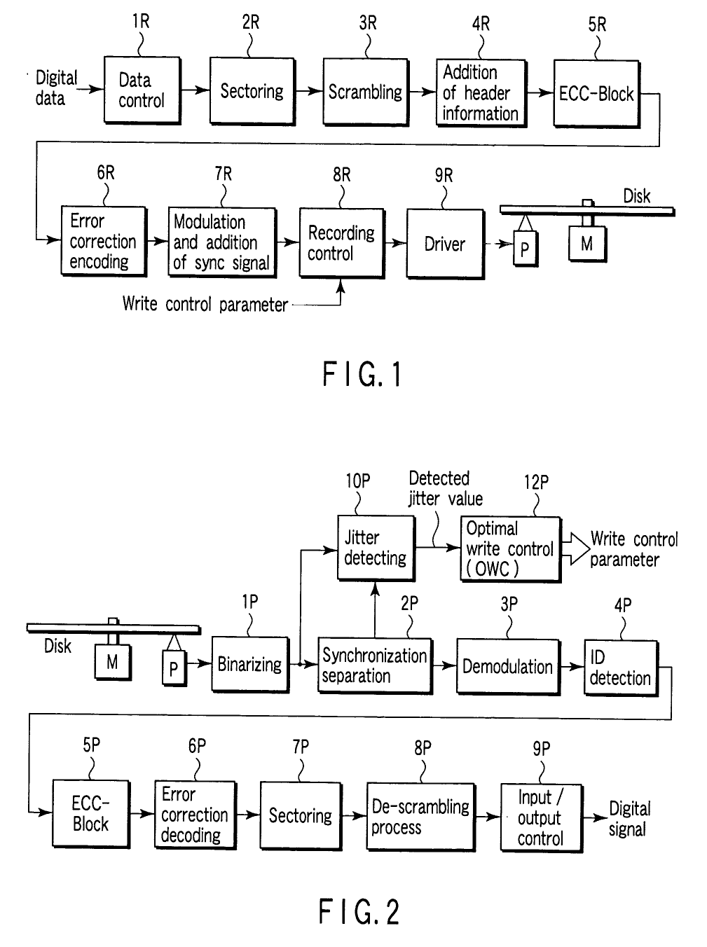

FIG. 1 is a view showing a general process when digital main data (recording digital data) is recorded in a recording medium such as a DVD. Recording digital data to be supplied from the outside is arranged at a data control unit 1R. The arranged digital data is divided into pack data in units of 2K bytes (2 KB) at a sectoring unit 2R. At the sectoring unit 2R, 4-byte EDC which is an error detection code is generated for data in units of 2 KB, and is added to the pack data. Each item of 2 KB pack data (with the EDC) is sent to a scrambling unit 3R in order to carry out a process for producing random data which is a process targeted for stabilizing a disk servo after recorded. The sent pack data is subjected to a scrambling process. To the scrambled 2 KB data pack, header information such as a sector ID is added by means of a header information adder unit 4R, and the added header information is sent to an error correcting code block (ECC-Block) generator unit 5R. Although the sequence of the scrambling process and header information adding process may be reversed, the header information or the like is not scrambled. For sector pack data composed of (header)+(main data)+(EDC), 16 sets of the data are collected at the error correction code generator unit 5R, and are configured in one ECC block. In units of the ECC blocks, each of which is a set of packs, an error correction code is generated and added by an error correction encoder unit 6R. In the DVD specifications, a product code with an inner parity (PI) and an outer parity (PO) is employed for an error correction code. However, after the correction code has been generated, the outer parity (PO) is interleaved, and the interleaved parities are allocated in a distributive matter, so that 16 sets of recording sectors having like configuration are reorganized.

FIG. 6 is a view showing a configuration of an ECC block which has been row-interleaved after a correction code has been generated in a DVD.

FIG. 7 shows a recording sector structure in a DVD.

A recording sector generated by such a process is subjected to a modulation process and a synchronizing signal adding process by means of a modulator and sync adder unit 7R. One row in FIG. 7 is divided into 2 synchronization frames, and a synchronizing signal is added at the head of each of the synchronization frames.

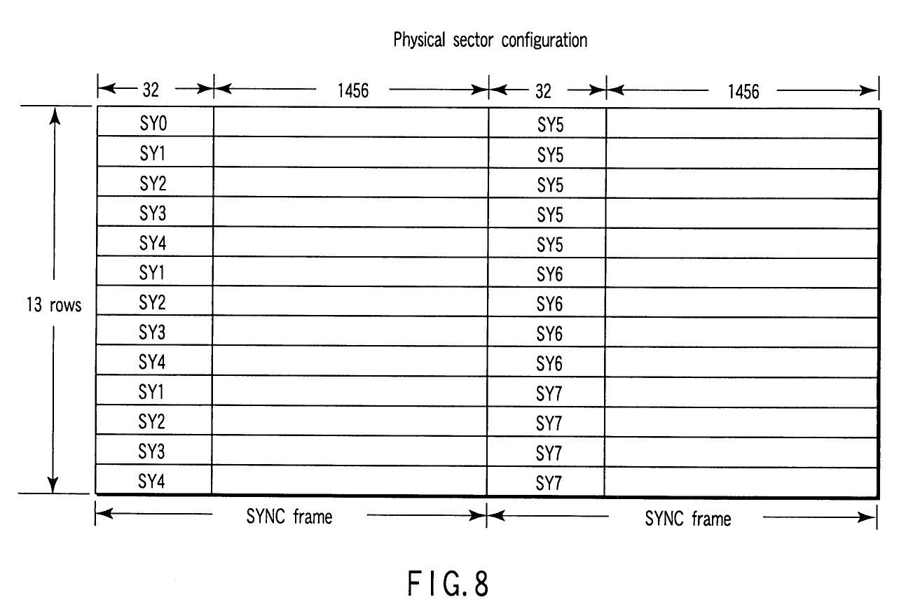

FIG. 8 is a view showing a configuration of the thus generated physical sector. The physical sector data having a structure as shown in FIG. 8 is subjected to writing power or timing control based on medium characteristics or a pre-signal or post-signal pattern of a recording signal by means of a recording control unit 8R. Then, a laser diode (LD, not shown) of a pickup head P writes data into a disk by a driver 9R.

The recording control in such a recording system is performed as follows. A write control parameter is set by a “Write strategy code” of a DVD-R medium or “Physical Format Information” of a DVD-RAM medium, etc. which is recorded in advance in a recording medium. Occasionally, there is employed a technique for, while changing a parameter value to a plus or minus from the recorded parameter, repeating recording and/or reproducing processes a plurality of times to check characteristics; extracting an optimal write control parameter; and setting a write control parameter of main data.

FIG. 2 is a view showing a general process for data reproduction of digital data read out from a recording medium such as a DVD. A pickup head P is opposed to a disk which is rotated by a motor M. The pickup head P includes a laser diode which is a light emitting element, a photo diode which is a detector element, and a head amplifier for amplifying an output of the photo diode. An RF signal read out by the pickup head (head amplifier) is binarized by means of a binarizing unit 1P, and the binary signal is sent to a synchronization separation unit 2P. The synchronization separation unit 2P generates a timing signal for channel bit separation, symbol separation, and synchronization frame separation, and reads out channel data. At this time, a jitter detecting unit 10P detects a jitter value indicating a phase relationship between a channel timing location, a leading edge and a trailing edge of a mark of a recording signal. The jitter value of a partial mark length is averaged in the same mark length, and the averaged value is stored to be used as write control parameter control data. A channel bit and symbol synchronized data sent out from the synchronization separation unit 2P are sent to a demodulation unit 3P, and symbol data is modulated. From the thus demodulated data stream, a sector ID is detected by an ID detecting unit 4P. ECC data blocks for 16 physical sectors are collected by an error correction code encoder unit 5P. Then, an error location and an error pattern are detected by an error correction decoder unit 6P, and error data is corrected. The error corrected data is handled as a data packet in units of sectors by means of a sectoring unit 7P. The data packet is de-scrambled by a de-scrambling unit 8P, and digital data is output from an input and output control unit 9P to the outside.

In parallel to the above-described reproduction processing, the jitter detector 10P detects a jitter value according to units of combinations of a mark length and a space length in Table 1 and Table 2 described later, and sends the detected value to an optimal writing control unit (OWC) 12P. The optimal writing control unit 12P carries out a process for optimizing a write control parameter described later.

The description of recording and reproducing process with reference to FIG. 2 has now been completed. Now, recording control in a recording system will be described here by way of example of a DVD-RAM medium and a DVD-R medium.

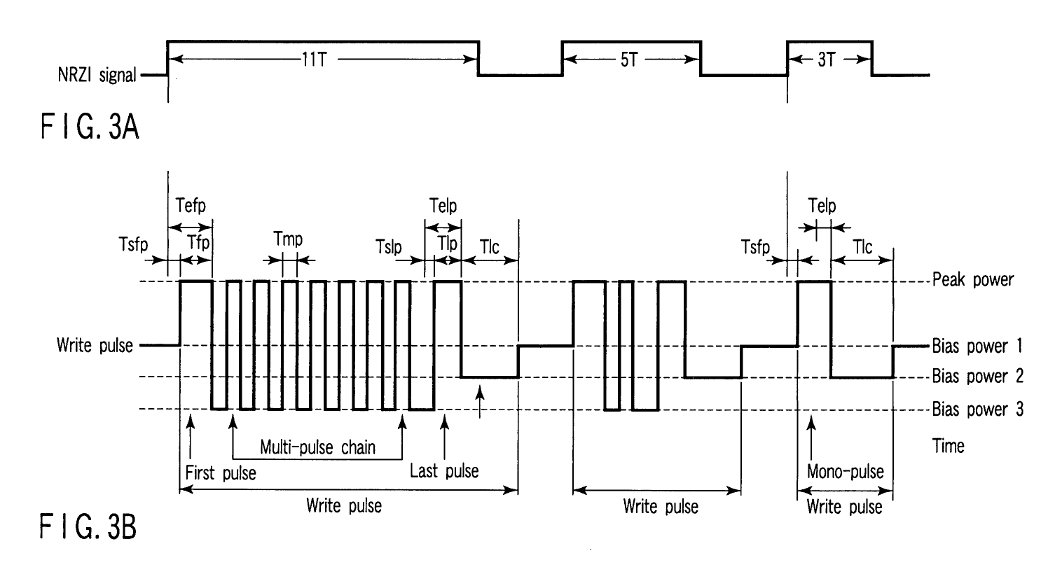

FIGS. 3A and 3B are views each showing a writing waveform during recording in a DVD-RAM medium.

FIG. 3B shows a shape of a write pulse in response to an NRZI signal which is a recording signal shown in FIG. 3A. This example describes each of the cases of mark length 11 T, space length 3 T, mark length 5 T, space length 3 T, and mark length 3 T.

In optical disk mark edge recording scheme (recording scheme having significance in leading edge and trailing edge phases of each mark), a write pulse of a 3 T mark length is formed in the shape of a mono-pulse waveform. However, in the case of a mark length more than 3 T, a comb shaped multi-pulse signal recording is made. In this scheme, a writing waveform is not prone to be formed in the shape of a “tearful eye”, and is obtained as a write pulse waveform suitable to a mark edge recording scheme. Here, the recording control unit 8R in FIG. 1 controls a first write pulse width, multiple write pulse widths, a last write pulse width and the like in FIG. 3B so as to be an optimal recording signal according to a recording medium to be used. Further, Tsfp (a time from a leading edge of an NRZI signal to a leading edge of the first write pulse) and Telp (a time from a location which precedes by last 2 T of the NRZI signal to a trailing edge of the last write pulse) are controlled based on a relationship between a recording mark length and a space length. In this manner, parameters are controlled so that writing signals are optimized at all the mark lengths.

TABLE 1

Mark length

| Tsfp | | 3T | 4T | 5T | 6T |
|---|---|---|---|---|---|
| Preceding | 3T | a | b | c | D |
| space | 4T | e | f | g | H |
| length | 5T | i | j | k | l |
| | More | m | n | o | p |
| | than 5T | | | | |

TABLE 2

Mark length

| Telp | | 3T | 4T | 5T | 6T |
|---|---|---|---|---|---|
| Succeeding | 3T | q | r | s | t |
| space | 4T | u | v | w | X |
| length | 5T | y | z | aa | ab |
| | More | ac | ad | ae | af |
| | than 5T | | | | |

Table 1 and Table 2 are Tsfp and Telp parameter control tables, respectively. That is, Tsfp is a matrix of a recording mark length relevant to a space length which precedes a recording mark, and the associated time is controlled. Telp is a matrix of a recording mark length relevant to a space length which succeeds a recording mark, and the associated time is controlled. Data (write control parameters) on cross points in these tables each are recorded in advance as a “Write Strategy Code” in land pre-pit information contained in a lead-in area of a DVD-RAM medium. However, the data is not used intact. In a process for optimizing and setting a parameter, the data is recorded with a value changed to a plus or minus from a reference value of a parameter recorded in advance, and a jitter of a reproduction signal of the data is detected. In this manner, an optimal value suitable to a recording medium used at that time is determined, and the determined optimal parameter is used for actual recording of main data.

In order to carry out a recording and reproducing test for such write control parameter optimization, a rewritable data zone is present next to an embossed pre-pit area in a lead-in area. In this data zone, a test zone is allocated.

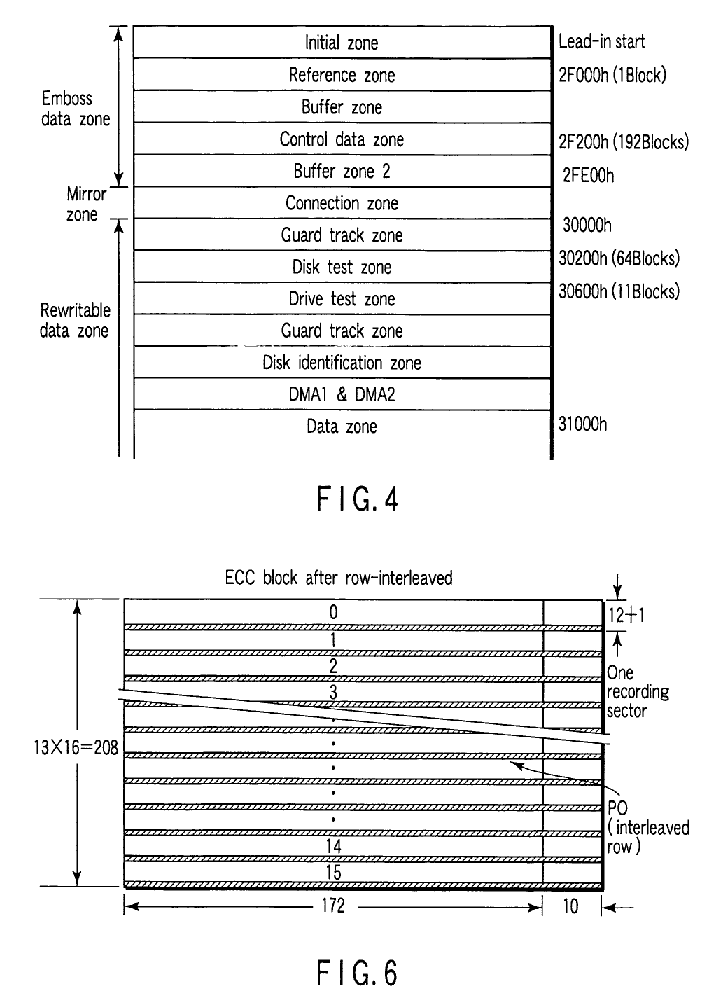

FIG. 4 illustrates a structure of a lead-in area of a DVD-RAM medium.

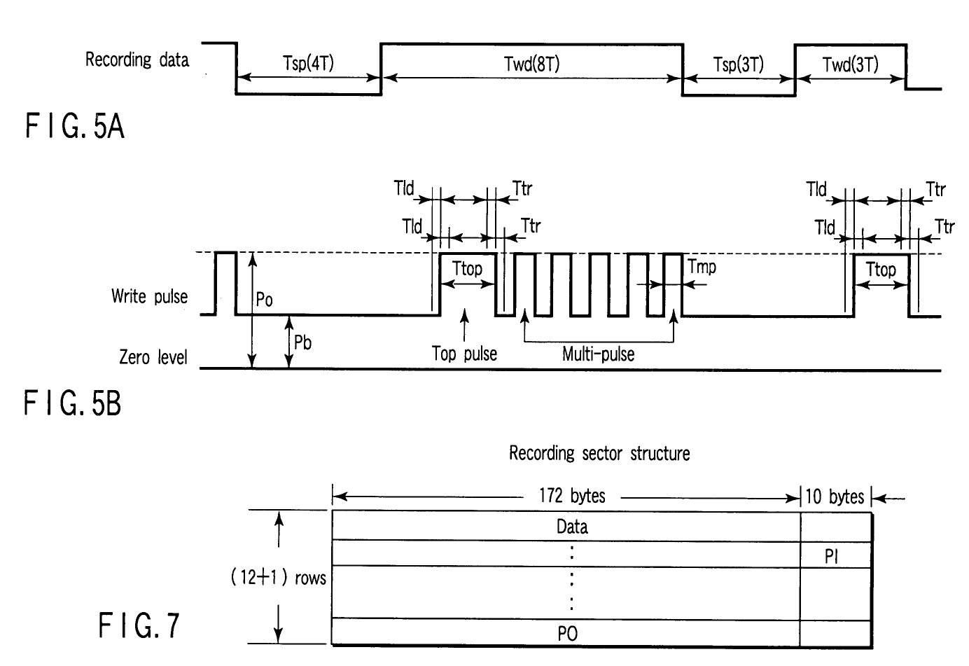

FIGS. 5A and 5B each illustrate a writing waveform of a recording strategy of a DVD-R medium. A write pulse of the DVD-R medium comprises a top pulse and a multi-pulse. The shift quantities of the leading edge and trailing edge of the top pulse are changed based on a relationship between a mark length and a space length. This write control parameter is recorded as a “Write Strategy Code” in the land pre-pit information contained in the lead-in area of the DVD-R medium. Based on this value, a value converted from the drive characteristics is used to record a main signal.

In this manner, an optical disk recording and reproducing drive has carried out the following:
test recording by changing to a plus or minus a write control parameter recorded in advance in a recording medium such as a DVD-RAM;
reproducing a test recording signal; and
extracting an optimal value of the write control parameter. In addition, a recording medium such as a write once type DVD-R medium has carried out the following:
a recording and reproducing test before shipment of a drive based on media manufacturer information or a preset parameter value;
preparing an optimal parameter conversion table to store conversion data in a drive; and
making up an optimal recording condition from parameter conversion on a medium by medium basis during a write operation by a user.

The write control parameters recorded in advance in the recording medium are write control parameters which a medium manufacturer has checked and extracted by using a standard drive. These write control parameters do not match with the recording characteristics made up by an equipment configuration unit of a drive manufacturer. Thus, the above-described system for extracting a recording control optimal parameter is mandatory to a drive configuration.

In the case where a digital signal is recorded in a recording medium such as an optical disk, a sector ID or the like is added while the digital signals are collected in units of specific packs. Then, an error detection correction code is generated and added. Then, addition of a sync signal and a modulating process for a recording signal are applied, and the modulated signal is converted and recorded in a recording signal waveform suitable to a recording medium. In a CD or a DVD, a read only disk or a write once type and rewritable type disk are standardized on the same platform. In the read only medium, it is better to provide a scheme in which the shortest pit becomes large so as to easily form a pit. Thus, a mark edge recording scheme (recording scheme having significance in the leading edge and trailing edge phase of each mark) is employed. Therefore, for a modulation scheme, when a DVD is taken as an example, 8-16 RLL (Run Length Limited) modulation for code converting an 8-bit data symbol into a 16-channel bit is carried out; and NRZI modulation for inverting a recording signal in a bit of the converted channel code “1” is combined.

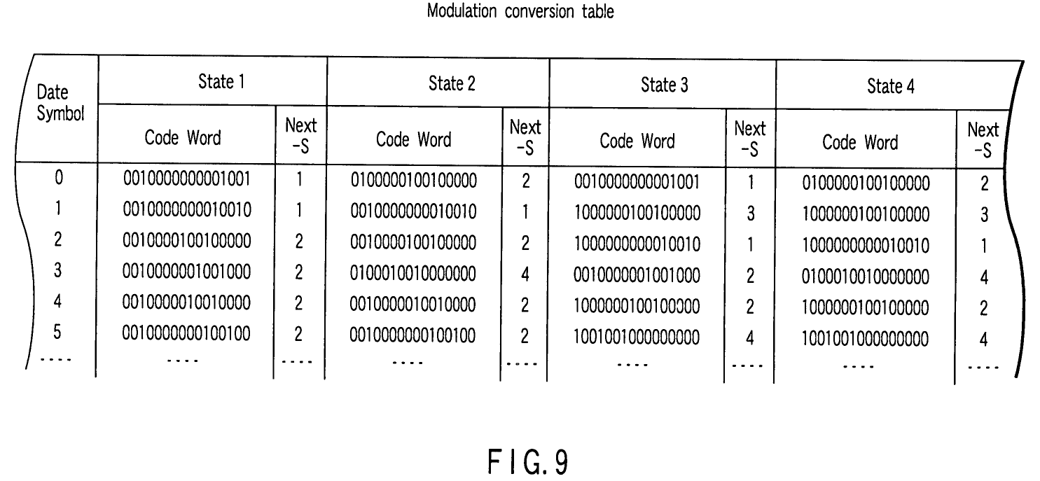

FIG. 9 shows a portion of a conversion table of a data symbol and a channel bit code. In the figure, State 1 to State 4 are provided to prevent infringement by changing a conversion table chart based on the preceding and succeeding data relationship so as to ensure that the shortest pit or longest pit after modulated does not violate a modulation rule when the data symbol has been changed to the channel bit. Such a recording signal after modulated corresponds to the NNRZI signal of FIG. 3A or recording data of FIG. 5A. This recording signal is recorded in the recording medium. However, in the case of a phase change (PC) scheme for carrying out recording in a recording medium due to optical heat generation such as a CD or a DVD, even if a laser light beam is controlled as is by means of an NRZI signal, the NRZI signal cannot be correctly reproduced as a reproduction signal. Thus, actual optical power is controlled so that a mark signal on the recording medium becomes the NRZI signal during reproduction by carrying out write processing using the multi-pulse signal as shown in FIG. 3B or 5B.

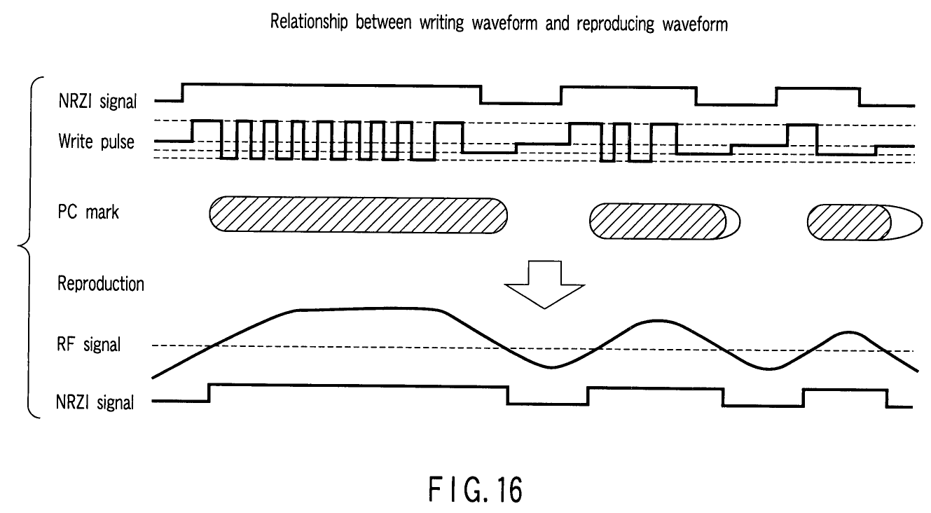

FIG. 16 shows a relationship between a writing waveform and a reproducing waveform. Data is modulated, and an NRZI signal is obtained as a recording signal. This signal causes a laser diode to output a write pulse in a multi-pulse waveform, and a phase change mark (“PC mark” of FIG. 16) is formed in the recording medium. Such a phase change mark is detected by applying a reading laser light beam to the medium and detecting a reflecting light, and an electrical signal is read an RF signal. The RF signal is reproduced as an original NRZI signal by means of a binarizing circuit. This NRZI signal is passed through a demodulator, and digital data is reproduced. Based on this relationship, in order to ensure that the NRZI signal during recording is reproduced as an NRZI signal in the same waveform, a correct phase change mark must be formed. This control is made by controlling waveform parameters (time parameters) such as Tsfp or Telp of FIG. 3B and Tld or Ttr of FIG. 5B as well as by controlling an optical power. Since these parameters are changed according to recording medium characteristics or drive characteristics, detection and setting processes of an optimizing parameter are important.

Now, data processing in DVD specifications will be described in order to facilitate understanding of an embodiment.

FIG. 6 is a view showing an ECC block after generating and adding an error correction code described with reference to FIG. 1. In a DVD system, a product code is employed as an error correction scheme, and thus, an outer parity (PO) and an inner parity (PI) are generated. A row interleaving process is carried out after the outer parity (PO) has been generated, and the row-interleaved codes are allocated in a distributed manner so as to ensure that a recording sector comprises 13 (=12+1) rows.

FIG. 7 shows a structure of the thus made up recording sector. This recording sector is subjected to a modulating process, a synchronizing signal is added, and a physical sector is formed. This physical sector is shown in FIG. 8. 172 bytes per row in FIG. 7 is converted to 456 channel bits×2 by 8-16 RLL modulation, and a synchronizing signal of 32 channel bits are added at the head of a respective bit. As a result, one row comprises two Synchronization frames.

FIG. 9 shows a portion of a conversion table of 8-16 RLL modulation.

Now, a detailed description of optimizing a write control parameter in the embodiment of the present invention will be given by way of example of the DVD scheme.

A write pulse structure is described in section 2.8.1.3.1 “Write Pulse” of the “DVD Specification for Rewritable Disc/Part 1 Physical Specifications”. This specification relates to 3 T mark writing and 3 T or more mark writing. As shown in Table 1 and Table 2, a description is given such that a First Pulse start timing or a Last Pulse start timing (a Pulse width is changed as a result) is controlled based on a relationship between a mark length and a space length. The reference write control parameter is described as “Physical Format Information” in a Control Data Zone in section 5.7.1 “Lead-in area” in the same specification.

A reference value of this write control parameter is obtained as a parameter indicating that a predetermined performance is achieved as a result of standard drive evaluation by a recording medium manufacturer. This parameter does not match with actual drive characteristics. Thus, in the drive, test data is recorded/reproduced as initial setting in a Disc Test Zone of the lead-in area shown in FIG. 4, and the reference value of the write control parameter is corrected based on a detection result of a reproduction jitter. Then, an optimal value of the write control parameter for main data recording is set.

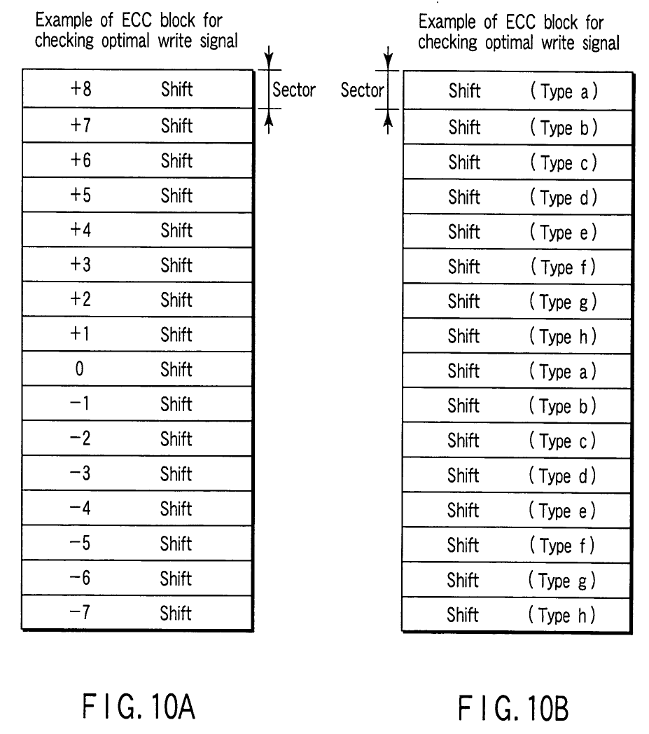

FIG. 10A is a view showing an example of recording an ECC block for optimizing a write control parameter in one embodiment of the present invention. Test data is recorded by a write pulse obtained by (level shifting from +8 to −7 through 0) correcting a reference value of a write control parameter (Tsfp, Telp shown in Table 1 and Table 2) in units of predetermined levels, i.e., in units of sectors in one ECC block composed of 16 recording sectors as shown in FIG. 6. This ECC block is recorded in a Disc Test Zone of a lead-in area. At this time, as recording data, there is employed random data on which a relationship between a mark length and a space length shown in Table 1 and Table 2 frequently occurs.

After such data has been recorded, that block is reproduced. At this time, jitter values of the leading edge and trailing edge of a mark are classified based on the preceding and succeeding space lengths, and accumulated average values are calculated, respectively. This process is carried out in units of sectors, whereby jitter performance can be detected in level units of write control parameters. From this detection result, a shift value of a parameter whose jitter performance is the best is set as an optimal value of a write control parameter for use in recording main data. This process is carried out on a disk by disk basis so that an optimal value suitable to a disk to be used is set.

Conventionally, a final parameter has been detected and set by a technique called a climbing detection technique by:
changing and recording a reference value of a write control parameter in a predetermined level;
reproducing that block;
detecting a jitter;
changing the parameter in an opposite direction to make recording again; and
repeating a reproducing/jitter detecting process of that block while reducing a parameter change level.

However, there has been a problem that a long detection time is required. When detection is carried out within a short time, the number of parameter change points is reduced, thus worsening reliability of an optimal point. However, in the present embodiment, since a parameter value is changed on a sector by sector basis of the ECC block, an optimal parameter value can be detected within a short time merely by one recording and reproducing process. Further, a number of combinations of parameter items can be supported, and reliability can be improved.

FIG. 10B shows an example of recording different types of combinations in units of sectors. FIG. 10A shows that Tsfp, Telp in Table 1 and Table 2 have been recorded by changing them uniformly by a predetermined level, and FIG. 10B shows a method for setting different parameter change levels for each combination of a mark length and a space length. That is, type-a of FIG. 10B sets a shift level which is different depending on each of 16 combinations such as −5 for a combination of mark length T3 and space length 3 T or +2 for a combination of mark length 4 T and space length 3 T. Although only one ECC block is used in FIGS. 10A and 10B, test data may be recorded in a plurality of ECC blocks.

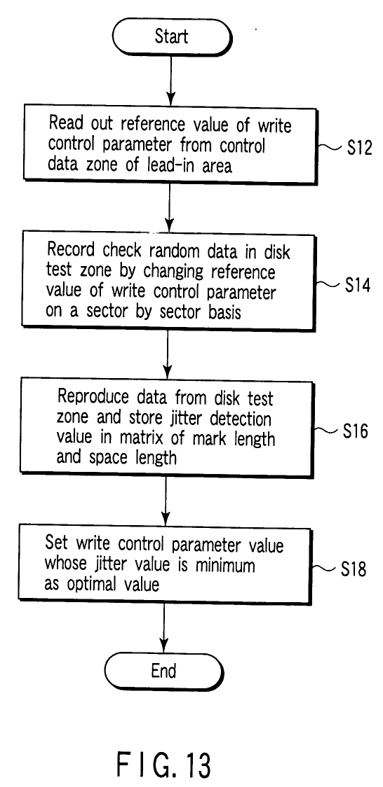

FIG. 13 is a flow chart showing procedures for detecting and setting a write control parameter in initial settings as shown in FIGS. 10A and 10B.

In step S12, a reference value of a write control parameter is read out from a control data zone of a lead-in area.

In step S14, random data for use in check is recorded in a disk test zone of the lead-in area by shifting the reference value of the write control parameter uniformly as shown in FIG. 10A, or alternatively, shifting the reference value according to a combination of a mark length and a space length as shown in FIG. 10B.

In step S16, recording data is read out from the disk test zone, and a jitter detection value is stored in a matrix table between a mark length and a space length on a parameter value (shift value) by parameter value (shift value) basis.

In step S18, a shift level or a shift pattern is determined whose jitter value is the smallest, and an optimal parameter value is set according to the determination (the optimal value is stored in a write strategy memory of the optimal recording control unit 12P).

As has been described above, according to the present embodiment, unlike a conventional technique, there is no need for a feedback system for detecting and setting a final parameter in accordance with a technique called a climbing detection technique by:
changing and recording a reference value of a write control parameter in a predetermined level;
reproducing that block;
detecting a jitter;
changing the parameter in an opposite direction to make recording again; and
repeating a reproducing/jitter detecting process of that block while reducing a parameter change level.

Therefore, it is possible to correct a change of an optimal point caused by the fact that a test region and an actual data recording and reproducing region are different from each other in place by applying to a general information recording and reproducing operation.

As has been described above, according to the first embodiment, an optimal value of a write control parameter can be detected by one recording and reproducing operation, and a sufficient amount of data on a parameter variation data can be obtained, thus improving reliability.

Random data on one data packet is provided in number such that an average value can be extracted as data on each cross point in a combination of a mark length and a space length in Table 1 and Table 2. In this manner, data on one recording condition can be obtained in one data packet, thus making it possible to efficiently detect a write control parameter.

The DVD specification defines that one sector comprises 2 Kbytes, making it possible to set parameters in units of single sectors or in units of plural sectors and making it easy to carry out processing.

In order to obtain an optimal value, a recording control is changed from a reference value, thus making it difficult to carry out reproduction or detection. Therefore, a synchronizing signal is recorded by using the reference value. In this manner, the synchronizing value can be stably detected.

In a DVD-RAM/R/RW or the like, parameter data is recorded in advance in a recording medium. By defining that value as a reference, its optimal value can be approximately predicted, thus making it possible to prevent a parameter value from being changed up to an uncorrectable level.

In a CD or the like, no parameter data is recorded in advance in a recording medium. However, manufacturer data can be detected from the recording medium. Therefore, optimal values investigated on a manufacturer by manufacturer basis are stored in advance in a nonvolatile memory contained in a drive, and the optimal values are selectively used from the nonvolatile memory, whereby the initial value of the write control parameter for optimization can be determined.

Hereinafter, a description will be given with respect to another embodiment of a write control parameter optimizing apparatus and method and a recording apparatus and method according to the present invention. In such another embodiment, like constituent elements in the first embodiment are designated by like reference numerals. A detailed description is omitted here.

### SECOND EMBODIMENT

A block diagram of a second embodiment is not shown here because it is the same as that of the first embodiment.

As has been described above, according to the present invention, unlike a conventional technique, there is no need for a feedback system for carrying out recording and reproduction, detecting a jitter, and then, based on the detection result, obtaining an optimal parameter value while carrying out recording and reproduction again. Therefore, it is also possible to correct a change of the optimal value of the write control parameter caused by the fact that a test region and an actual data recording and reproducing region are different from each other in place by applying to a general recording and reproducing operation. The second embodiment for achieving such correction will be described here.

In the second embodiment, the following system is employed. An initial value of an optimal value of a write control parameter is set in accordance with techniques as shown in FIGS. 10A and 10B, and then, main data is recorded and reproduced in a data region. At this time, in a portion of a recording region, the write control parameter is recorded with slightly changing it. That portion is reproduced in accordance with a predetermined timing, the jitter values of a changed portion and a predetermined parameter portion which is not changed are compared with each other, and the optimal values of the set write control parameters are sequentially corrected.

As shown in FIG. 11, a last row of one sector (for example, sector 8) in one ECC block is recorded with slightly changing the write control parameter. In general, in the case where the write control parameter has been slightly changed, it is considered that the jitter value increases or decreases. As a result, a slight ransom error occurs. However, in the DVD scheme or the like, a product code is employed as an error correction code, and in particular, with respect to the outer parity (PO), the error code signal is obtained as a set of interleaved data in a recording data stream. Thus, correction capability is high. Even if an entire one row breaks, a 1-symbol error merely occurs, and therefore, data output after error correction is not affected so much. In actuality, the jitter value slightly changes, there is a very low possibility that an error occurs on the entire row, and a parameter change is considered to hardly cause a problem.

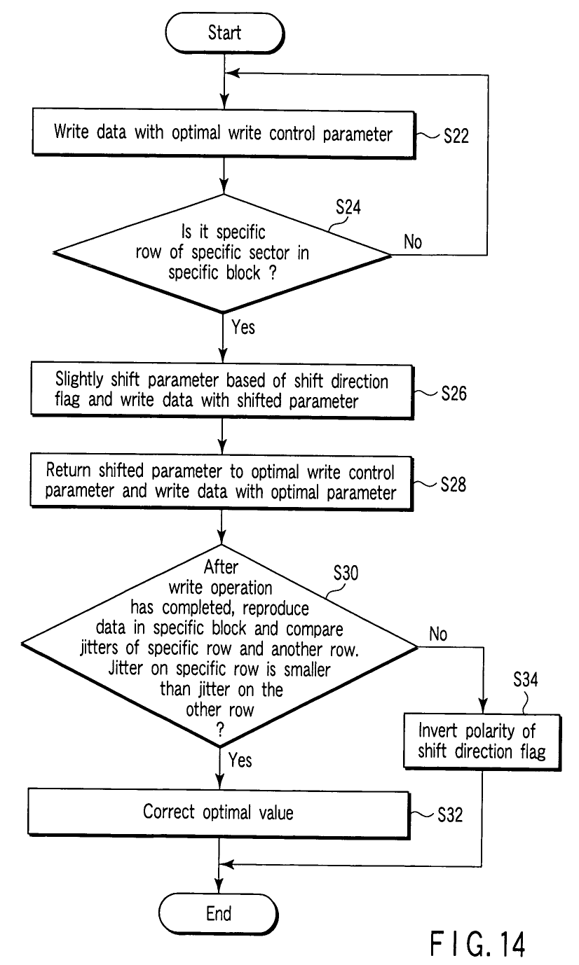

FIG. 14 is a flow chart showing procedures for carrying out sequential correction as shown in FIG. 11.

Main data is recorded in step S22 based on an optimal value of the set write control parameter. In step S24, it is determined whether or not a recording location is a specific row (herein referred to as a bottom row) of a specific sector (herein, referred to as sector 8) in a predetermined ECC block. When the determination result is negative, processing returns to step S22. When the determination result is affirmative, processing advances to step S26. In step S26, the optimal value of the write control parameter is slightly changed and recorded. When recording of the specific row completes, processing goes to step S28 in which the write control parameter is returned to the optimal value, and recording is continued. Then, processing goes to step S30 in which recording data on the predetermined ECC block is reproduced, and the jitter values between a row on which the main data is recorded by an optimal value of the write control parameter and a specific row on which the parameter has been changed and the main data is recorded by the changed value of the write control parameter are compared with each other. When the jitter value of the specific row is smaller, processing goes to step S32 in which the optimal value of the write control parameter is corrected (the write control parameter used for specific row recording is defined as an optimal value). When the jitter value of the specific row is not smaller, processing goes to step S34 in which the polarity of a shift direction flag is inverted.

In this way, by utilizing a main data recording and reproducing process, it becomes possible to sequentially make an optimization check of a write control parameter, and it becomes possible to set optimal write control parameters in an entire recording medium. This check may be made at only three portions, an inner periphery, an outer periphery, and an intermediate portion, or alternatively, may be made on a block by block basis.

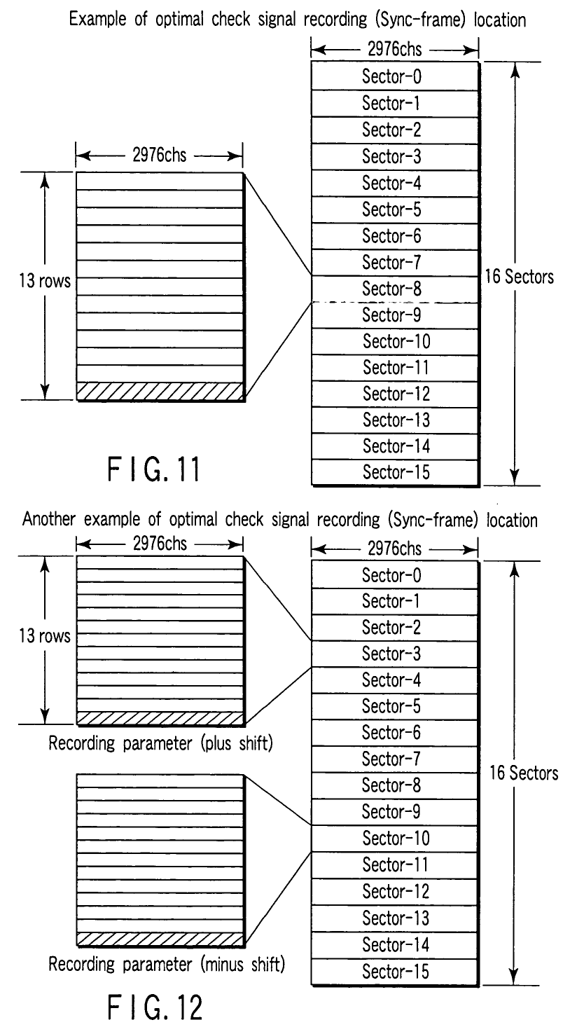

FIG. 12 is a view showing another example of change of a write control parameter when an ECC block is recorded. Although one row in one ECC block has been handled as a check row in FIG. 11, a plurality of rows in one ECC block are handled as check rows in FIG. 12. Then, a row on which a parameter is shifted to a plus side and a row on which the parameter is shifted to a minus row are incorporated. This reproduction result and the optimal value of the write control parameter are compared with each other. In this manner, when a parameter is changed, which of the directions an optimal point has been shifted can be determined merely in the block, and it is possible to facilitate sequential correction.

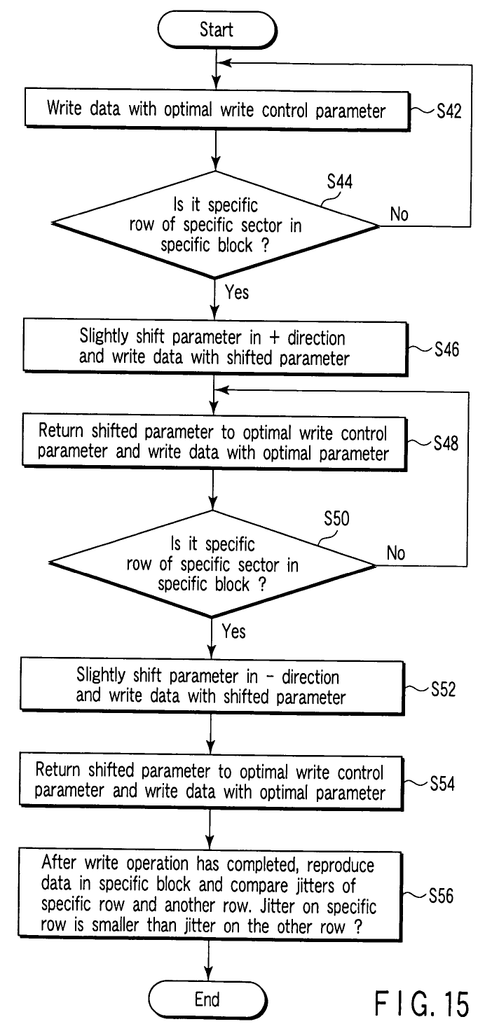

FIG. 15 is a flow chart showing procedures carrying out sequential correction as shown in FIG. 12.

Main data is recorded in step S42 by an optimal value of a set write control parameter. In step S44, it is determined whether or not a recording location is a specific row (herein referred to as a bottom row) of a first specific sector (herein referred to as sector 3) in a predetermined ECC block. When the determination result is negative, processing returns to step S42. When the determination result is affirmative, processing advances to step S46. In step S46, the optimal value of the write control parameter is slightly changed to a plus side, and the main data is recorded by the slightly changed value. When a specific row recording competes, processing goes to step S48 in which the write control parameter is returned to the optimal value, and recording is continued. Processing goes to step S50 in which it is determined whether or not a recording location is a specific row (herein referred to as a bottom row) of a second specific sector (herein referred to as sector 10) in the predetermined ECC block. When the determination result is negative, processing returns to step S48. When the determination result is affirmative, processing goes to step S52. In step S52, the optimal value of the write control parameter is slightly changed to a minus side, and the main data is recorded by the slightly changed value. When a specific row recording completes, processing goes to step S54 in which the write control parameter is returned to the optimal value, and recording is continued. Then, processing goes to step S56 in which recording data on the predetermined ECC block is reproduced; the jitter vales between a row on which the main data is recorded by an optimal value of the write control parameter and a specific row on which the parameter has been changed and the main data is recorded by the changed value of the write control parameter are compared with each other; and the optimal value of the write control parameter is corrected in accordance with the comparison result.

As has been described above, according to the second embodiment, when main data is recorded, a write control parameter of a specific row of a specific sector in an ECC block is slightly changed and recorded; and jitter values of reproduction signals in a case where the parameter is not changed and in a case where the parameter is changed are compared with each other, whereby the optical value of the write control parameter can be corrected in real time, and a change of an optimal value according to a recording location can be compensated for.

(1) According to the write control parameter optimizing apparatus of the embodiment of the present invention, the optimal value of the write control parameter can be detected by one recording and reproducing operation, and a sufficient amount of data on parameter variation can be obtained, thus improving reliability.

(2) According to the recording apparatus of the embodiment of the present invention, the optimal value of the write control parameter can be detected by one recording and reproducing operation, and a sufficient amount of data on parameter variation can be obtained, thus improving reliability.

(3) According to the write control parameter optimizing apparatus of the embodiment of the present invention, the optimal value of the write control parameter can be detected in real time, thus making it possible to always carry out recording whose reproduction characteristics are good irrespective of the recording location.

(4) According to the recording apparatus of the embodiment of the present invention, the optimal value of the write control parameter can be detected in real time, thus making it possible to always carry out recording whose reproduction characteristics are good irrespective of the recording location.

(5) According to the write control parameter optimizing apparatus of the embodiment of the present invention, the optimal value of the write control parameter can be detected by one recording and reproducing operation, and a sufficient amount of data on parameter variation can be obtained, thus improving reliability.

(6) According to the recording apparatus of the embodiment of the present invention, the optimal value of the write control parameter can be detected by one recording and reproducing operation, and a sufficient amount of data on parameter variation can be obtained, thus improving reliability.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. A write control parameter optimizing apparatus for use in a recording apparatus for recording digital data in a recording medium by using a write pulse light determined based on a write control parameter, the write control parameter optimizing apparatus comprising:
means for recording random data as data packets by using different write pulse lights determined by increasing and decreasing the write control parameter by a predetermined value;
means for reproducing the data packets;
means for detecting jitter from each of the reproduced data packets; and
means for determining an optimal value of the write control parameter according to a detection result of the detecting means.

2. A write control parameter optimizing apparatus according to claim 1, wherein the random data recording means comprises means for recording data packets by using write pulse lights including not less than a predetermined number of combinations between a recording mark length and a space length.

3. A write control parameter optimizing apparatus according to claim 1, wherein the data packet comprises one or more sectors of 2 Kbytes to 8 Kbytes.

4. A write control parameter optimizing apparatus according to claim 1, wherein the data packet comprises synchronization frames, and a recording mark in a data region in which a synchronizing signal is excluded from each of the synchronization frames is recorded and controlled based on the write control parameter.

5. A write control parameter optimizing apparatus according to claim 1, wherein the data packet comprises synchronization frames, plural data packets configuring an error correction block, and
the random data recording means comprises means for increasing and decreasing the write control parameter in units of data packets and in units of predetermined values α (+mα, . . . , +α, 0, −α, . . . , −nα) (wherein m and n denote positive integers), thereby recording random data.

6. A write control parameter optimizing apparatus according to claim 5, wherein the predetermined value α is different depending on a combination of a mark length and a space length.

7. A write control parameter optimizing apparatus according to claim 1, wherein the random data recording means comprises means for recording random data by using different power and waveform write pulse lights determined by increasing and decreasing the write control parameter based on a specific relationship according to a combination of a mark length and a space length.

8. A write control parameter optimizing apparatus according to claim 1, wherein the write control parameter is set by a recording medium manufacturer, and is recorded in a recording medium.

9. A write control parameter optimizing apparatus according to claim 1, wherein the write control parameter is stored in the recording apparatus on a recording medium by medium basis set by a recording medium manufacturer, and is read out from the recording apparatus based on manufacturer information detected from the recording medium.

10. A recording apparatus comprising:
means for recording random data as data packets by using different write pulse lights determined by increasing and decreasing by a predetermined value a write control parameter for determining a write pulse light for use in recording digital data in a recording medium;
means for reproducing the data packets;
means for detecting jitter from each of the reproduced data packets;
means for determining an optimal value of the write control parameter according to a detection result of the detecting means; and
means for recording digital data in the recording medium by using write pulse lights determined based on the optimal value of the write control parameter.

11. A write control parameter optimizing apparatus for use in a recording apparatus for recording digital data in a recording medium by using a write pulse light determined based on a write control parameter, the write control parameter optimizing apparatus comprising:
means for recording data in a predetermined area in a predetermined error correcting code block with changing the write control parameter by a predetermined value, the error correcting code block comprising data packets, each data packet comprising rows of synchronization frames;
means for reproducing data from the predetermined error correcting code block;
means for detecting jitter from the reproduced predetermined error correcting code block; and
means for determining an optimal value of the write control parameter according to the detection result of the detecting means.

12. A write control parameter optimizing apparatus according to claim 11, wherein the predetermined area of the predetermined error correcting code block is one row of a specific data packet in an error correcting block or rows of an integer multiple of the row of the specific data packet.

13. A write control parameter optimizing apparatus according to claim 12, wherein the one row of the specific data packet is a row of error correction parity data.

14. A write control parameter optimizing apparatus according to claim 12, wherein the row of the integer multiple of the row of the specific data packet is a row on which the data is recorded with the write control parameter changing to a plus side and a row on which the data is recorded with the write control parameter changing to a minus side.

15. A write control parameter optimizing apparatus according to claim 11, wherein the recording medium comprises a write once type recording medium.

16. A write control parameter optimizing apparatus according to claim 11, wherein main data is converted into test random data so that jitter can be detected and the test random data is recorded in the predetermined area of the predetermined error correcting code block with changing the write control parameter.

17. A recording apparatus comprising:
means for recording random data as data packets by using different write pulse lights determined by increasing and decreasing by a predetermined value a write control parameter for determining a write pulse light for use in recording digital data in a recording medium;
means for recording data in a predetermined area in a predetermined error correcting code block with changing the write control parameter by a predetermined value, the error correcting code block comprising data packets, each data packet comprising rows of synchronization frames;
means for reproducing data from the predetermined error correcting code block;
means for detecting jitter from the reproduced predetermined error correcting code block; and
means for determining an optimal value of the write control parameter according to the detection result of the detecting means; and
means for recording digital data in the recording medium by using a write pulse light determined based on the optimal value of the write control parameter.

18. A recording apparatus according to claim 17, wherein the predetermined area of the predetermined error correcting code block is one row of a specific data packet in an error correcting block or rows of an integer multiple of the row of the specific data packet.

19. A write control parameter optimizing method for use in a recording apparatus for recording digital data in a recording medium by using a write pulse light determined based on a write control parameter, the write control parameter optimizing method comprising the steps of:
recording random data as data packets by using different write pulse lights determined by increasing and decreasing the write control parameter by a predetermined value;
reproducing the data packets;
detecting jitter from each of the reproduced data packets; and
determining an optimal value of the write control parameter according to a detection result of the detecting step.

20. A recording method comprising the steps of:
recording random data as data packets by using different write pulse lights determined by increasing and decreasing by a predetermined value a write control parameter for determining a write pulse light for use in recording digital data in a recording medium;
reproducing the data packets;
detecting jitter from each of the reproduced data packets;
determining an optimal value of the write control parameter according to a detection result of the detecting step; and
recording digital data in the recording medium by using write pulse lights determined based on the optimal value of the write control parameter.
